(19) United States
(12) Patent Application Publication
(10) Pub. No.: US 2014/0302882 A1
(43) Pub. Date: Oct. 9, 2014

(54) REDUCING INTERFERENCE

(71) Applicant: Neul Ltd., Cambridge (GB)

(72) Inventor: William Webb, Cambridge (GB)

(73) Assignee: Neul Ltd., Cambridge (GB)

(21) Appl. No.: 14/248,972

(22) Filed: Apr. 9, 2014

(30) Foreign Application Priority Data
Apr. 9, 2013 (GB) 1306424.1

(51) Int. Cl. H04W 72/08; H04W 52/04

(52) U.S. Cl. CPC H04W 72/082; H04W 52/04
USPC 455/509

(57) ABSTRACT

A terminal is configured to operate in white space in a wireless communications network, the terminal including: a transmitter for transmitting a wireless signal on a channel lying in the frequency range 450 MHz to 800 MHz; a power controller for setting the transmit power of the wireless signal at a transmit level by adjusting the gain of a power amplifier, wherein the power controller is configured to detect a commencement time for a transmission burst and to adjust the gain over a ramping period from an initial level to the transmit level; and a data generator configured to generate ramping data for transmission during the ramping period and information data for transmission at the transmit level, wherein the ramping period is in the range 10 ms to 1 s.

### SUMMARY

The invention relates to reducing interference caused by one or more terminals operating in a wireless network.

A wireless network may be configured to operate without having been specifically allocated any part of the electromagnetic spectrum. Such a network may be permitted to operate in so-called whitespace: a part of the spectrum that is made available for unlicensed or opportunistic access. Typically whitespace is found in the UHF TV band and spans 450 MHz to 800 MHz, depending on the country. A large amount of spectrum has been made available for unlicensed wireless systems in this frequency range.

A problem with operating in whitespace is that the available bandwidth is variable and cannot be guaranteed. These limitations are well-matched to the capabilities of machine-to-machine networks in which there is no human interaction. Machine-to-machine networks are typically tolerant of delays, dropped connections and high latency communications.

Any network operating in the UHF TV band has to be able to coexist with analogue and digital television broadcast transmitters. The density of the active television channels in any given location is relatively low (resulting in the availability of whitespace that can be used by unlicensed systems). The FCC has mandated that systems operating in the whitespace must reference a database that determines which channels may be used in any given location. This is intended to avoid interference with the TV transmissions and certain other incumbent systems such as wireless microphones.

For TV receivers (including those for digital TV (DTV)), there will inevitably be adjacent channels on which a strong transmission close to the TV receiver will interfere with TV reception. For example, the TV receivers may have image frequencies and poor adjacent channel rejection (ACR) on certain frequencies due to image frequencies in their mixers and limitations in their receive filters. These frequencies are often dependent on the specific receiver implementation.

Digital TV typically uses a channel bandwidth of 6 to 8 MHz. It also uses OFDM modulation in which the overall channel bandwidth is split into a large number of narrower channels (so-called sub-carriers), each of which is individually modulated. The system is designed so that, if a certain number of sub-carriers are subject to multipath fading, with the result that their signal-to-noise ratio is poor, the overall data can still be recovered. This is typically achieved by using interleaving and error correction codes, which mean that bit errors localised to a limited number of sub-carriers can be corrected. OFDM modulation can therefore achieve considerable robustness to multipath fading.

OFDM is only able to recover the transmitted data when the interferer is relatively narrowband compared with the bandwidth of the overall TV signal, such that a limited number of sub-carriers are affected. OFDM does not provide a similar performance benefit when the interferer occupies a relatively large proportion of the DTV channel bandwidth because in this case the error control coding may be incapable of correcting the bit errors due to the higher proportion of bits that may be corrupt. If the bandwidth of the transmitted signal from the terminal can be reduced to a small fraction of the DTV channel bandwidth, there is a lower chance of the DTV receiver being unable to decode the signal correctly. Another perspective on this is that the narrowband whitespace transmitter can be located much closer to the DTV receiver before causing noticeable degradation of the decoded DTV signal. This can be of particular benefit for mobile or portable whitespace devices whose exact location and antenna orientation cannot be easily constrained.

However, there is another constraint on the location of terminals vis-à-vis TV receivers to minimise interference. Devices that transmit bursty signals (that is, transmit short bursts of information, turnoff, then after a while turn on again and repeat) cause more interference to TV receivers than a device transmitting a constant signal, even where the channel frequencies which have been allocated would indicate a lower level of interference. One way of reducing interference is to control power levels of transmissions from the wireless devices. Maximum transmit power levels can be governed by a central base station or network controller having heed to possible interference with TV receivers and other devices. The effect of “bursty” signals means greater margins need to be built into white space power allocations to make sure interference is minimised. This can consequently have an effect on signal-to-noise ratios and accuracy rates for transmissions from the devices.

It would be desirable to be able to reduce the effect of interference from wireless devices on other equipment, e.g. TV receivers, in the vicinity without sacrificing power allocation.

According to an aspect of the present invention, there is provided a terminal configured to operate in white space in a wireless communications network, the terminal comprising: a transmitter for transmitting a wireless signal on a channel lying in the frequency range 450 MHz to 800 MHz; a power controller for setting the transmit power of the wireless signal at a transmit level by adjusting the gain of a power amplifier, wherein the power controller is configured to detect a commencement time for a transmission burst and to adjust the gain over a ramping period from an initial level to the transmit level; and a data generator configured to generate ramping data for transmission during the ramping period and information data for transmission at the transmit level, wherein the ramping period is in the range 10 ms to 1 s.

Another aspect of the invention provides a method of reducing interference to television receivers resulting from wireless transmissions from a terminal configured to operate in whitespace in a wireless communications network, the method comprising, at the terminal: detecting a commencement time for a transmission burst; adjusting the gain of a power amplifier operating to adjust the transmit power of a signal over a ramping period in the range of 10 ms to 1 s from an initial level to a transmit level; transmitting ramping data during the ramping period and thereafter transmitting information data in the transmission burst, wherein the ramping data and the information data are transmitted in a frequency range of 450 MHz to 800 MHz.

The inventors have noticed that the interference problem can be much reduced by “slow ramping”. In this context, “slow” relates to a time to ramp up from an initial value of gain for the power amplifier (zero or a standby level) to its transmit level over a period much longer than the current switch-on time of a device. For example, the ramp time can be between 10 ms to 1 s, for example 80-120 ms. 100 ms has been found to have a good effect in reducing interference. By transmitting ramping data during the ramp time, a TV receiver in the vicinity has more time to adapt to the presence of a new signal by adjusting its own automatic gain control (AGC) parameters, and thus the transmission from the wireless device has a reduced interfering effect.

The technique can be used to particular advantage in the context of a white space wireless network where there are a plurality of potentially transmitting wireless devices (terminals). Each terminal can be configured to transmit the dummy signal during the ramp time over a “ramping” channel, and then switch to a transmission channel for transmission of the information signal. Where there are a plurality of terminals in a vicinity, the ramping channel can be a common channel utilised by multiple terminals, whereas the transmission channel is unique to each terminal.

The terminal can be configured to receive the identity of the ramping channel from a controller via a wireless control message for example, from a central controller or base station. Alternatively, the terminal can be configured to select the ramping channel based on a network protocol which is understood by all wireless devices (terminals) in the vicinity, such that the same channel is selected by multiple terminals.

A further aspect of the invention provides a method of reducing interference in a wireless communications network wherein multiple terminals are each transmitting wireless signals in the same allocated transmission period, each terminal transmitting its information signal on a uniquely allocated channel for the period, the method comprising, at each terminal: detecting a commencement time for the transmission period; adjusting the gain of a power amplifier operating to adjust the transmit power of a signal over a ramping period from an initial level to a transmit level; transmitting ramping data during the ramping period on a ramping channel which is a common channel to the other terminals and thereafter transmitting information data on its uniquely allocated channel.

A further aspect of the invention provides a wireless communications network comprising: multiple terminals each configured to transmit wireless signals in the same allocated transmission period, each terminal transmitting its information signal on a uniquely allocated channel for the period each terminal configured to detect a commencement time for the transmission period, to adjust the gain of a power amplifier operating to adjust the transmit power of a signal over a ramping period from an initial level to a transmit level, and transmit ramping data during the ramping period on a ramping channel which is a common channel to the other terminals and thereafter transmit information data on its uniquely allocated channel; and a network controller configured to transmit to the terminals their respective unique information channels.

Aspects of the present invention will now be described by way of example with reference to the accompanying drawings. In the drawings:

### BRIEF DESCRIPTION OF THE DRAWINGS

FIG. 1 shows an example of a machine-to-machine network;

FIG. 2 is a schematic block diagram of a terminal; and

FIG. 3 shows an example of a frame structure.

### DESCRIPTION OF THE PREFERRED EMBODIMENTS

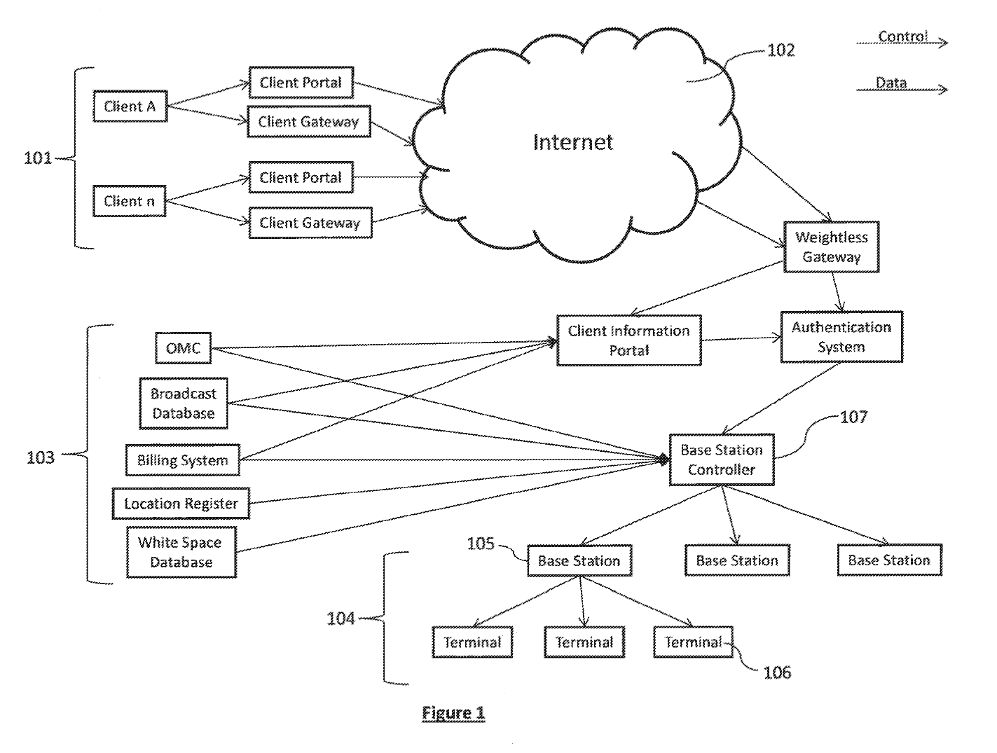

An example of a wireless network is shown in FIG. 1. The network, shown generally at 104, comprises one or more base stations 105 that are each capable of communicating wirelessly with a number of terminals 106. Each base station may be arranged to communicate with terminals that are located within a particular geographical area or cell. The base stations transmit to and receive radio signals from the terminals. The terminals are suitably entities embedded or machines or similar that communicate with the base stations. Suitably the wireless network is arranged to operate in a master-slave mode where the base station is the master and the terminals are the slaves.

The base station controller 107 is a device that provides a single point of communication to the base stations and then distributes the information received to other network elements as required. That is, the network is based around a many-to-one communication model. The network may be arranged to communicate with a client-facing portion 101 via the internet 102. In this way a client may provide services to the terminals via the wireless network.

Other logical network elements shown in this example are:
Core network. This routes traffic information between base stations and client networks.
Billing system. This records utilisation levels and generates appropriate billing data.
Authentication system. This holds terminal and base station authentication information.
Location register. This retains the last known location of the terminals.
Broadcast register. This retains information on group membership and can be used to store and process acknowledgements to broadcast messages.
Operations and maintenance centre (OMC). This monitors the function of the network and raises alarms when errors are detected. It also manages frequency and code planning, load balancing and other operational aspects of the network.
Whitespace database. This provides information on the available whitespace spectrum.
Client information portal. This allows clients to determine data such as the status of associated terminals, levels of traffic etc.

In practice, many of the logical network elements may be implemented as databases running software and can be provided on a wide range of platforms. A number of network elements may be physically located within the same platform.

A network such as that shown in FIG. 1 may be used for machine-to-machine communications, i.e. communications that do not involve human interaction. Machine-to-machine communications are well-matched to the limitations of operating in whitespace, in which the bandwidth available to the network may vary from one location to another and also from one time instant to the next. As the network does not have any specific part of the spectrum allocated to it, even unallocated parts of the spectrum may become unavailable, e.g. due to a device in the vicinity that is operating outside of the network but using the same part of the spectrum. Machines are able to tolerate the delays and breaks in communication that can result from these varying communication conditions. Services can be provided in non real-time; low latency is not important as long as data is reliably delivered.

The base station controller 107 determines, for each and every cell, which frequencies are permitted for whitespace use. The controller may perform this step by accessing the whitespace database to rule out those frequencies reserved for licensed users. The controller may then determine what frequencies are otherwise excluded as being unsuitable. It may, for example, rule out as being unsuitable frequencies on which an unacceptably high level of interference has been found. The controller produces a finalised list of frequencies that are available to each cell. The controller uses this list to generate a frequency hopping sequence for each cell, which is then communicated to the appropriate base station.

Frequency hopping minimises the interference to TV reception, since no communication will be permanently causing interference to any given TV receiver. Frequency hopping also reduces the probability of the terminal being in a long-term fade. It provides a form of interleaving that enables more efficient error correction to be used.

The channels used for frequency hopping may be selected by the base station based upon information from the whitespace database on the available channels and associated power levels (which in turn are based upon the licensed spectrum use in the area). However, the whitespace database does not include information about every possible source of interference.

Once the controller has established which frequencies are available for use in each cell it can start to allocate frequency hopping sequences. It is preferable for the sequences to contain as many frequencies as possible to reduce the impact of fading etc, as discussed above. However, the sequences should also be generated so as to minimise the occasions on which neighbouring cells will be transmitting on the same frequency, as this can cause interference to the terminals in each cell (particularly those located near to a cell boundary). The controller may employ an algorithm to determine every possible frequency sequence across the cells of the network to analyse which arrangement will generate the least amount of overlap between neighbouring cells.

A preferred option is for the available frequencies to be arranged in a predetermined order, with each cell starting its respective hopping sequence at a different frequency in the order from its neighbouring cells. The predetermined order might be random or worked out according to some rule. For example, the available frequencies might simply be organised into ascending or descending order. Preferably, each cell commences its respective sequence at a different offset from its neighbour, so that at any given time each cell is using a different frequency in the sequence from its neighbour. Simulations have shown that cyclic frequency hopping sequences function very well with such an offset, without the unfeasible computational burden associated with looking at all possible frequency hopping sequences across all cells.

Generating the sequences to simply comprise a list of available frequencies arranged in a predetermined order and then applying a respective offset for each cell works particularly well in networks arranged to operate in whitespace. This is because the frequencies available for use in whitespace are largely dictated by the frequencies that are already allocated to TV channels. Different TV transmitters may use different frequencies (which is why the spectrum available to whitespace networks is dependent on the location of that network); however, each TV transmitter is associated with a large geographical region. Typically, a transmitter may cover an area having a radius of around 50 miles. This means that neighbouring cells will largely have the same set of frequencies available to them. When this is the case, neighbouring cells can be prevented from overlapping in their frequency hopping sequences simply by applying an offset in each cell.

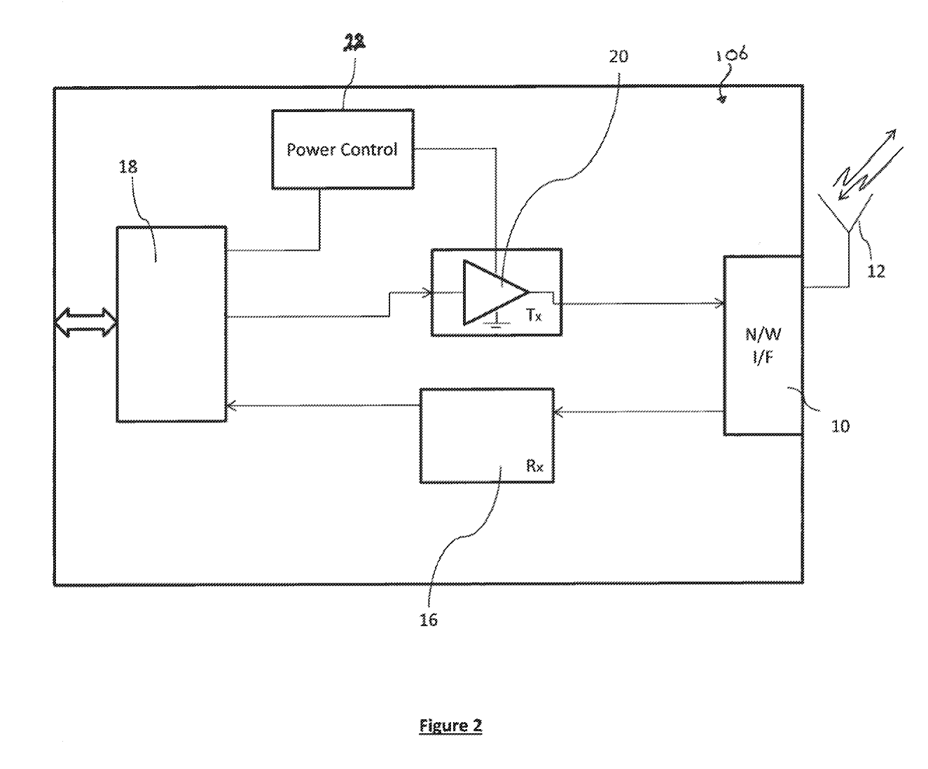

FIG. 2 is a schematic functional diagram of a terminal device 106. Each device comprises a network interface 10 which is connected to an antenna 12 for receiving and transmitting wireless signals. The terminal 106 includes a transmit block 14 and a receive block 16. The transmit block is responsible for receiving data to be transmitted, modulating that data onto a carrier and supplying it to the network interface for transmission as a wireless signal from the antenna 12. The receive block 16 is responsible for receiving incoming wireless signals from the network interface 10 and processing those signals into digital data. A data processing unit 18 handles the digital data which is supplied to the transmit block 14 and received from the receive block 16. It will be appreciated that FIG. 2 is highly schematic, and that much of the detail of operation of the terminal has been omitted for ease of explanation. The operation of the terminal in this respect is known in the art. The transmit block 14 includes a power amplifier 20. The gain of the power amplifier 20 is managed under the control of a power control function 22. Although shown as a separate block in 106 (again for ease of explanation), in fact this function is likely to be implemented as part of a control sequence executed by the DPU 18. The power control function 22 sets the gain of the power amplifier 20 for transmission of the wireless signal. Each terminal 106 transmits signals on the uplink modulated onto a carried frequency within the white space spectrum. Channels (which can be frequency bands or time slots) are allocated to terminals by their base stations as briefly discussed above. The white space is a part of the UHF band typically spanning 470 MHz to 790 MHz. Each channel is a spectrum allocation of around 6 to 8 MHz. Each carrier or subcarrier is for a transmission in a single channel or subchannel. Subchannels are discussed later. Transmission from the terminals are in bursts, each burst comprising a plurality (or at least one) frame of payload (information data) and an error checking chunk (e.g. a CRC frame). Bursts may be infrequent or at least spaced apart by intervals with a minimum spacing of approximately [2 seconds]. In order to conserve power, the terminal 106 can be powered down in between bursts. In order to effect transmission of a burst, the terminal firstly has to power up from an inactive state (standby or off). At turn-on, the gain of the power amplifier 20 is adjusted to a transmit level for the signal. This transmit level is controlled by a number of factors, including a setting received from the network controller or the base station. Other factors include SNR (Signal-to-Noise Ratios) and other QUIs (Quality Indications) at the terminal. Power control in such terminals is known and is not discussed further herein. What is important is that, once determined, a transmit level for the signal is determined by the gain of the power amplifier 20. In order to minimise switching transients which occur during sharp bursts of RF energy, a ramp shape is applied by the power control function 22 to adjust the gain of the power amplifier 20. At present, ramp times of around 250 μs are utilised. While a ramp is desirable to minimise transients, it is also desirable to minimise the ramp time as far as possible to avoid wasting transmission time in an allocated channel, which could otherwise be used for transmission. The ramp shape can be applied both in turn-on and turnoff, and bits can be supplied by the DPU for transmission during the ramp time. These are referred to herein as ramping bits—they carry no information and do not form part of the transmitted “burst” which is a burst of information bits or information data modulated onto the carrier and which will be understood by a recipient. The ramping bits are provided to minimise the effect of switching transients in a sharp burst of RF energy.

It has been noted by the present inventors that the effect of interference on surrounding TV receivers in the vicinity of terminals can be markedly reduced if the ramp time is significantly extended. For example, a ramp time of 100 ms has been demonstrated to have a noticeable effect in reducing interference on surrounding TV receivers operating in the white space. Ramp times in the range of 10 ms to 1 s also have the desired effect of reducing interference.

The effect on surrounding TV receivers (and other equipment that may be attempting to receive and transmit signals in the white space) appears to result by allowing them time to adjust to the interference from the burst transmitted from the terminal. That is, such TV receivers and other equipment tend to operate automatic gain control or other arrangements to accommodate surrounding interference. By giving such circuitry adequate time to respond, the effect of such interference can be reduced.

As already noted, a potential disadvantage of increasing ramp time is “wasted spectrum” in the uplink allocation. This can be ameliorated by “ramping” on a subchannel and then jumping to an alternative channel for transmission where several terminals can be “ramping” on the same subchannel. Channel allocation has been discussed above. A channel in this context is a spectrum allocation of a narrow bandwidth, for example, 8 MHz in Europe and 6 MHz in the USA. Subchannels can be created by utilising subcarriers, where a carrier is divided into smaller frequency elements, for example, sixty four subcarriers. This allows a number of terminals to use separate uplink subchannels at the same time. For example, when adjacent and edge subcarriers are not utilised, around twenty four terminals can use separate subchannels at the same time.

According to the present embodiment, one of those subchannels which is common to all of the terminals can be used by all of the terminals for “ramping”, where ramping data is transmitted during the ramp time. At the end of the ramp time, each terminal can switch to its unique allocated subchannel for the transmission of information data. This has a significant advantage that the “wasted spectrum” for ramping is much reduced. Furthermore, this can be while still reducing the interference effect on surrounding TV receivers and other equipment. That is, the point of the extended ramp is to “warn” surrounding equipment of interfering signals—the channel or subchannel on which this is achieved is unimportant.

The “ramping” subchannel can be allocated by the base station in the allocation phase, or it can be selected by the terminal according to a protocol known to the terminals. For example, it could always be the first subchannel in any allocation.

The selection of the ramping subchannel is carried out at the terminal 106 by the DPU 18, which controls the transmit block 14 accordingly. The carrier frequency can be selected in the transmit block by controlling a mixer in the transmit block or in any other known way. Selection of carrier frequencies for transmitting signals in wireless devices is known and is not discussed further herein. The novel part of the technique described in this part is to utilise a first subchannel (carrier frequency) for ramping in an extended ramp time, and then to switch to a transmission channel for the transmission of an information signal.

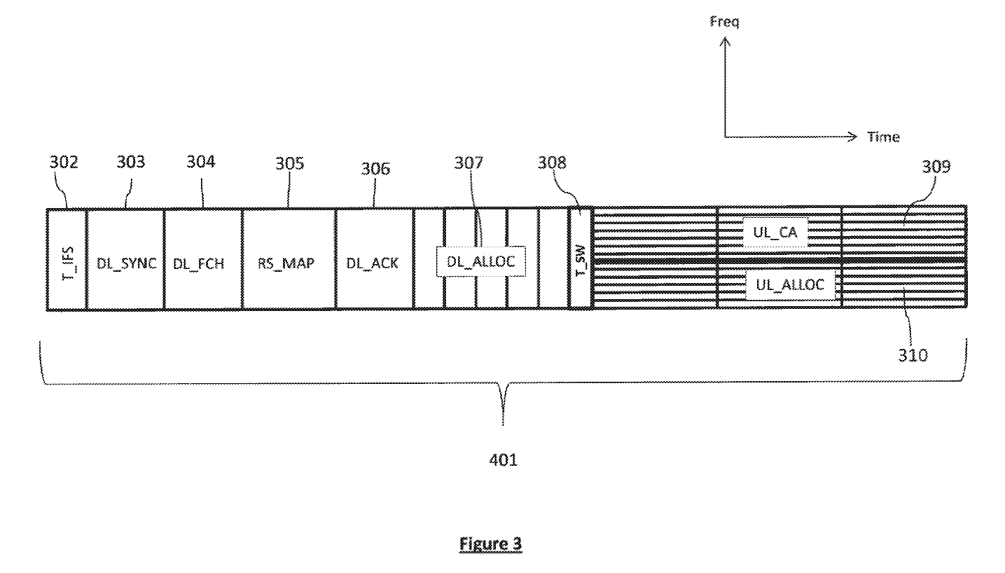

The network may use medium access control (MAC) to share the same radio resource between multiple terminals. An example of a suitable frame structure is shown in FIG. 3. The frame (shown generally at 401) comprises time to “tune” to a channel, including to ramp-up to full output power 302 (T_IFS), a synchronisation burst 303 (DL_SYNC), an information field providing the subsequent channel structure 304 (DL_FCH), a map of which information is intended for which terminal 305 (DL_MAP), a field to allow acknowledgement of previous uplink transmissions 306 (DL_ACK) and then the actual information to be sent to terminals 307 (DL_ALLOC). There is then a guard period for ramp-down of the downlink and ramp-up on the uplink 308 (T_SW), followed by the allocated uplink data transmissions 310 (UL_ALLOC) in parallel with channels set aside for uplink contended access 309 (UL_CA). In the present embodiments T-SW accommodates the extended ramp period.

A suitable hopping rate for the downlink channels may be the frame rate, so that each frame is transmitted on a different frequency from the preceding frame. The frames for a network designed to operate in whitespace for machine-to-machine communication may be particularly long. In one example the frames may each be 2 seconds long, giving a frequency hop on the downlink every 2 seconds (which is 30 hops per minute). In one example, the uplink portion is about 1 s allowing e.g., 100 ms of ramping time then 900 ms of data transmission. The ramping time and data transmission periods can be modified as appropriate.

The DL_FCH may include information to enable the terminals to determine the hopping sequence. The DL_FCH may include a list of the frequencies that are included in the sequence. One efficient way of communicating this information is by means of a channel map, with a bit being set if the channel is in use in the base station. The DL_FCH may also include a MAC Frame count (16-bit) enabling terminals to determine where the base station is in its hopping pattern.

The DL_MAP informs terminals as to whether there is any information for them in the frame and whether they have an uplink slot reserved for them to transmit information. It comprises a table of terminal identities, the number of slots that their information is spread over and the transmission mode and spreading factors used. All terminals monitoring the frame decode this field to determine whether they need to decode subsequent information. The length of the DL_MAP may be included as part of the DL_FCH. A terminal can determine the position of its assigned slots from the DL_MAP by adding up the number of slots allocated in prior rows in the table.

On the uplink the slots may be numbered from 0 to n on the first FDMA channel, then on the subsequent FDMA channel and so on. The terminal can determine how many slots there are each channel from the length of the frame available for the uplink (that remaining after completion of the downlink) divided by the length of each slot. If a terminal has data requiring multiple slots it would normally be given these consecutively on the same carrier as this both simplifies the terminal transmission and minimises the control information required to describe the slot location. However, it is possible to give the terminal multiple allocations on different carriers (so long as they are not simultaneous) to achieve frequency hopping on the uplink.

1. A terminal configured to operate in white space in a wireless communications network, the terminal comprising:
a transmitter for transmitting a wireless signal on a channel lying in the frequency range 450 MHz to 800 MHz;
a power controller for setting the transmit power of the wireless signal at a transmit level by adjusting the gain of a power amplifier, wherein the power controller is configured to detect a commencement time for a transmission burst and to adjust the gain over a ramping period from an initial level to the transmit level; and
a data generator configured to generate ramping data for transmission during the ramping period and information data for transmission at the transmit level, wherein the ramping period is in the range 10 ms to 1 s.

2. A terminal according to claim 1, wherein the transmitter is configured to transmit the ramping data on a ramping channel, and to transmit the information data on an information channel.

3. A terminal according to claim 2, comprising a controller configured to receive a channel allocation command for the transmission burst identifying the ramping channel and the information channel.

4. A terminal according to claim 2, comprising a controller configured to determine the ramping channel based on a network protocol.

5. A terminal according to claim 1, wherein the ramping period is in the range 80 to 120 ms.

6. A method of reducing interference, the method comprising, at a terminal:
detecting a commencement time:
adjusting the gain of a power amplifier operating to adjust the transmit power of a signal over a ramping period from an initial level to a transmit level; and
transmitting ramping data during the ramping period and thereafter transmitting information data.

7. A method according to claim 6, comprising reducing interference to television receivers resulting from wireless transmissions from a terminal configured to operate in whitespace in a wireless communications network, the method further comprising:
detecting a commencement time for a transmission burst;
wherein the ramping period if in the range 10 ms to 1 s,
the method further comprising:
transmitting the information in the transmission burst, wherein the ramping data and the information data are transmitted in a frequency range of 450 MHz to 800 MHz

8. A method according to claim 7, comprising transmitting the ramping data on a ramping channel, and transmitting the information data on an information channel.

9. A method according to claim 8, comprising receiving at the terminal a channel allocation command for the transmission burst identifying the ramping channel and the information channel.

10. A method according to claim 7, comprising determining the ramping channel based on a network protocol.

11. A method according to claim 7, wherein the ramping period is in the range 80 to 120 ms.

12. A method according to claim 6, comprising reducing interference in a wireless communications network wherein multiple terminals are each transmitting wireless signals in the same allocated transmission period, each terminal transmitting its information signal on a uniquely allocated channel for the period, the method further comprising, at each terminal:
detecting a commencement time for the transmission period; and
transmitting the ramping data during the ramping period on a ramping channel which is a common channel to the other terminals and thereafter transmitting the information data on its uniquely allocated channel.

13. A method according to claim 12, wherein the ramping period is in the range 10 ms to 1 s.

14. A method according to claim 13, wherein the ramping period is in the range 80 ms to 120 ms.

15. A method according to claim 12, wherein the ramping channel and the uniquely allocated channel are subchannels of an allocated channel spectrum.

16. A wireless communications network, comprising:
multiple terminals each configured to transmit wireless signals in the same allocated transmission period, each terminal transmitting its information signal on a uniquely allocated channel for the period, and each terminal configured to:
detect a commencement time for the transmission period, to adjust the gain of a power amplifier operating and adjust the transmit power of a signal over a ramping period from an initial level to a transmit level, and
transmit ramping data during the ramping period on a ramping channel which is a common channel to the other terminals and thereafter transmit information data on its uniquely allocated channel; and
a network controller configured to transmit to the terminals their respective unique information channels.

17. A wireless communications network according to claim 16, wherein the network controller is configured to transmit to the terminals a power level which indicates the transmit power of the signal.
